(19) United States
(12) Patent Application Publication
(10) Pub. No.: US 2014/0346706 A1
(43) Pub. Date: Nov. 27, 2014

(54) SYSTEM AND METHOD FOR PRODUCING PREFORMS

(71) Applicant: Airbus Operations GmbH, Hamburg (DE)

(72) Inventors: Tassilo WITTE, Stade (DE); Hannes WINTER, Stade (DE); Fabian ELING, Menden (DE)

(21) Appl. No.: 14/199,184

(22) Filed: Mar. 6, 2014

(30) Foreign Application Priority Data
May 21, 2013 (EP) 13 168 504.2

(51) Int. Cl. B29B 11/16; B29B 11/06

(52) U.S. Cl. CPC B29B 11/16; B29B 11/06
USPC 264/171.13; 425/505

(57) ABSTRACT

A system for producing a composite preform, especially for continuous preforming of reinforcing material for a composite component, is provided. The system includes: a feeding device for feeding one or more layers of preform material from a material supply along a process path; a heating device arranged in the process path for heating the one or more layers of the preform material fed along the process path to soften or activate a resin or binder in the one or more layers; and a forming device arranged in the process path downstream of the heating device and configured to shape or mould a cross-sectional profile of the one or more layers of preform material as the one or more layers are fed along the process path. A method for producing a composite preform is also provided.

### CROSS-REFERENCE TO RELATED APPLICATION

This application claims priority to European Patent Application No. 13 168 504.2, filed May 21, 2013, which is incorporated herein by reference in its entirety.

### TECHNICAL FIELD

The technical field relates to a system and method for producing a composite preform, and in particular, to a system and method for automated and continuous preforming of reinforcing material for a fibre-reinforced composite.

### BACKGROUND

Current manufacturing techniques employed in the production of aircraft and aircraft components do not provide a system or method for the high-volume manufacture of fibre-reinforced composite components having variable geometry and/or variable laminate structures. As a result, the manual effort required to produce such components is significant, which naturally also leads to substantial costs.

Other objects, desirable features and characteristics will become apparent from the subsequent summary and detailed description, and the appended claims, taken in conjunction with the accompanying drawings and this background.

### SUMMARY

According to various embodiments, provided is a new and improved system and method for use in production of fibre-reinforced composite components, especially preforms therefor, for the aircraft or spacecraft industry. In this regard, the system and method of the disclosure can desirably be fully automated and configured for continuous operation.

According to one aspect, therefore, the disclosure provides a system for producing a composite preform, and especially for continuous preforming of reinforcing material for a composite component, comprising: a feeding device for feeding one or more layers of preform material from a material supply along a process path; a first heating device arranged in the process path for heating the one or more layers of the preform material fed along the process path to activate a resin or binder in the one or more layers; and a forming device arranged in the process path downstream of the heating device which is configured to shape or mould a cross-sectional profile of the one or more layers of preform material as the one or more layers are fed along the process path.

By virtue of the fact that the feeding device may feed one or a plurality or layers of preform material from the material supply, the system of the present disclosure can be adapted to various preform configurations. That is, the number of layers and the composition of each layer of the preform material can be selected and/or adjusted for flexibility in production of the composite preform. Furthermore, the fact that the layers of preform material are shaped or moulded as they are fed along the process path provides for a continuous production process and this, in turn, can enable high-volume manufacture.

In an embodiment, the feeding device is configured to feed the one or more layers of preform material as elongate, generally continuous, webs (such as strips or sheets) in a longitudinal direction along the process path. In this regard the material supply generally comprises at least one spool, roll or reel of the preform material, which may then be drawn from the material supply as one or more layers of continuous web, e.g. strip or sheet. As noted briefly above, the preform material may be reinforcing material for a composite component, and particularly a fibre material for production of preforms for fibre-reinforced composite components. In particular, the fibre material may comprise a fibre array or a fabric, such as a woven or non-woven fabric, of any one or more of various different types of reinforcing fibres, including but not limited to glass fibres, carbon fibres, aramid fibres, or the like. The fibres are dry but may include resin or polymer coatings to assist bonding and shaping in production of the preform. Also, the preform material may include one or more layers of material, which may e.g. act as a resin or binder layer, and/or one or more wire mesh layer, e.g. for providing lightning protection in an aircraft application. The resin or binder may be a polymer, such as a thermoplastic or thermosetting polymer; examples include epoxy, polyester, vinyl ester, or the like. The one or more layers of preform material may be a plurality of layers of continuous web, such as strip or sheet material, which are drawn from a corresponding plurality of spools, rolls or reels. The individual layers of preform material may be essentially the same or may differ from one another depending on specific requirements for the preform.

In one embodiment, the feeding device comprises at least one pair of driven rollers for pulling the one or more layers of preform material from the material supply and feeding or conveying the layer(s) along the process path. Thus, the driven rollers may draw a continuous web from each of the spools, rolls or reels of the material supply, and the webs are then conveyed along the process path superposed with one another as layers of the preform material. In this way, the same drive rollers may draw all of the layers of preform material together to form a compound web which is then fed or conveyed along the process path.

In one embodiment, the first heating device includes at least one heater, and in one example, a plurality of heaters, for heating the one or more layers of the preform material fed along the process path substantially uniformly. The at least one heater may include any of a number of heat sources, such as hot air, induction, or infrared heating. The heating device activates and softens the resin or binder provided in the one or more layers to facilitate the subsequent shaping or moulding of the preform as well as bonding or fixing the preform material layers to one another.

In one embodiment of the present disclosure, the system may further comprise a laying device for laying or inserting a discrete or non-continuous section of preform material on or between the one or more layers fed along the process path. The laying device may therefore be used to add discrete and localised sections or portions of reinforcing preform material at specific critical positions, depending on the preform requirements. To this end, the laying device may comprise a transport head for picking-up, transporting, and laying or inserting the discrete or non-continuous section on or between the one or more layers. Therefore, the system may also include a consolidating device for consolidating or compressing or pressing together the one or more layers of preform material and/or a discrete or non-continuous section laid or inserted therein as they are fed along the process path. For this purpose, the consolidating device may include rollers, between which the layers and/or discrete sections of preform material are consolidated or compressed.

In one embodiment, the forming device is configured to shape or mould the cross-sectional profile of the preform material in a plane transverse to the direction of travel along the process path; i.e. transverse to the longitudinal direction of the web. Thus, in this embodiment, the composite preform produced may be elongate with a generally constant cross-sectional profile, as typical of structural components like ribs or stringers employed in a fuselage or airframe of an aircraft or spacecraft.

In one embodiment, the forming device includes a plurality of forming stations arranged in series along the process path to progressively shape or mould the cross-sectional profile of the preform material as the one or more layers are fed along the process path. By carrying out the shaping or moulding procedure at a series of stations or over a series of steps, the shaping or moulding is performed progressively, and the procedure has flexibility to be varied by adapting one or more of those stations. Furthermore, the forming device may include a rotary frame having at least one form or mould on a circumference thereof, in or on which the cross-sectional profile of the preform material is shaped or moulded. The circumference of the rotary frame may thus be arranged on the process path, with the rotary frame configured to rotate at a speed for which a tangential speed of the form or mould on the circumference of the rotary frame is substantially the same as the speed at which the one or more layers of preform material are fed along the process path by the feeding device. In this embodiment, therefore, the plurality of forming stations may be arranged in series on or around the circumference of the rotary frame. The rotary frame may comprise a plurality of forms or moulds arranged on or around the circumference thereof, and the plurality of forms or moulds may be separately detachable from the rotary frame. Accordingly, once a composite preform is finalised or completed in one of the forms or moulds, the preform material of that item may be severed or cut from the continuous web and the preform removed from the rotary frame within the form or mould; i.e. the form or mould itself can be removed or detached from the frame with a finished preform in it. That form or mould can then be placed in an infusion station, at which wet resin is then injected into a cavity of the mould and the preform held therein to produce a composite component. The resin is typically pressurized and forced into the preform under vacuum in a Resin Transfer Molding (RTM) process. Alternatively, the resin may be entirely pulled into the cavity under vacuum in a Vacuum Assisted Resin Transfer Molding (VARTM) process. The moulding processes allow precise tolerances and detailed shaping of the component but must be performed carefully to avoid weak spots in a final component resulting from the fabric of the preform not being saturated fully by the wet resin.

In one embodiment, the system may further comprise a preliminary forming station downstream of the first heating device, the preliminary forming station comprising a mould or form in or upon which the cross-sectional profile of the one or more layers of preform material undergoes a preliminary shaping or moulding before the one or more layers reach the forming device. Thus, in one embodiment, the system may include a second heating device arranged in the process path downstream of a preliminary forming station for heating the preform material fed along the process path before the one or more layers reach the forming device. In this way, the preform material can be heated again before the primary forming operation takes place.

According to one aspect, the disclosure provides a method of producing a composite preform, and especially a method of continuously preforming reinforcing material for a composite component, comprising: feeding one or more layers of preform material from a material supply along a process path; heating the one or more layers of the preform material fed along the process path to activate a resin or binder in the one or more layers; and forming or shaping a cross-sectional profile of the one or more layers of preform material as the one or more layers are fed along the process path.

The feeding may comprise feeding each layer of preform material as an elongate, and sometimes continuous, web (such as a strip or sheet) in a longitudinal direction along the process path, whereby the forming comprises shaping or moulding the cross-sectional profile of the one or more layers of preform material considered in a plane transverse to the longitudinal direction.

The forming may include a plurality of discrete forming operations carried out in series along the process path to progressively shape or mould the cross-sectional profile of the preform material as the one or more layers are fed along the process path. In this regard, the forming may include shaping or moulding the cross-sectional profile of the preform material around or on a circumference of a rotary frame. Thus, the rotary frame typically rotates with a tangential speed at a circumference thereof substantially equal to a speed at which the one or more layers of preform material is/are fed in the feeding. The rotary frame may comprise a plurality of forms or moulds arranged around the circumference thereof, and each of the plurality of forms or moulds may be separately detachable from the rotary frame.

The material supply may include at least one spool, roll or reel of preform material and the feeding step comprises drawing the one or more layers of preform material from the material supply and feeding or conveying them along the process path by driving at least one pair of rollers. That is, the one or more layers of preform material are drawn between the driven rollers and fed along the process path.

The method may further comprise laying or inserting a discrete or non-continuous section of preform material on or between the one or more layers of preform material fed along the process path. The method may also include the step of consolidating or pressing together the one or more layers of preform material and/or the discrete or non-continuous section of preform material fed along the process path, for example via rollers.

The method may comprise a preliminary forming operation in which the cross-sectional profile of the one or more layers of preform material undergoes a preliminary shaping or moulding before the one or more layers reach the forming device. In this preliminary forming operation, the cross-sectional profile of the one or more layers of the preform material is desirably shaped or moulded in a plane transverse to the travel direction or the longitudinal direction.

The system and method of the present disclosure thus allow the manual effort previously required in the production of fibre-reinforced composite components that have a variable geometry and/or variable laminate structures to be markedly reduced by new production techniques that can operate continuously and largely or fully automated. This, in turn, can substantially reduce the production costs, enable high-volume manufacture, and also increase quality and repeatability of the composite preform and component production. As will be apparent from the description of the various embodiments, both the system and method of this disclosure particularly lend themselves to the production of composite preforms for elongate structural components having a specific cross-section or profile.

According to one aspect, the present disclosure provides a fibre-reinforced composite component, especially for an aircraft or spacecraft, which includes a composite preform produced with a system or method according to any one of the embodiments of the present disclosure described above. In this regard, the composite preform may have been moulded in an RTM or a VARTM process to produce the composite component.

According to one aspect, the present disclosure may provide an aircraft or spacecraft that incorporates one or more of such fibre-reinforced composite components.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic side view of a system for producing preforms according to an embodiment at a stage of production;

FIG. 2 is a schematic side view of the system of FIG. 1 at a later stage of production;

FIG. 3 is a detailed perspective view of a heating unit in the system of FIGS. 1 and 2;

FIG. 4 is a schematic cross-sectional view of the forming of a preform profile at an initial forming stage;

FIG. 5 is a schematic cross-sectional view of the forming of a preform profile at a later forming stage;

FIG. 6 is a schematic perspective view of preform profiles before and after a bending operation;

FIG. 7 is a schematic cross-sectional view of the forming of a preform profile at a later forming stage;

FIG. 8 illustrates the geometry of a rotary forming device of the system for producing preforms according to an embodiment;

FIG. 9 is a schematic side view of a rotary forming device of the system for producing preforms according to an embodiment;

FIG. 10 is a cross-sectional side view detail of the fibre-reinforced composite material entering the rotary forming device of the system and traversing forming roller stations nos. 1 to 6;

FIG. 11 shows perspective views of forming roller stations nos. 1 to 5 from the detail view of FIG. 10;

FIG. 12 is a cross-sectional view illustrating the forming of the preform profile at forming roller station no. 6 of FIG. 10;

FIG. 13 is a perspective view of the forming of the preform profile in a first part of roller station no. 6;

FIG. 14 is a cross-sectional view illustrating the forming of the preform profile in a second part of roller station no. 6 of FIG. 10;

FIG. 15 is a cross-sectional view illustrating the forming of the preform profile in a third part of roller station no. 6 of FIG. 10;

FIG. 16 is a cross-sectional view illustrating the forming of the preform profile in a fourth part of roller station no. 6 of FIG. 10;

FIG. 17 is a diagram that illustrates a method of producing a preform according to an embodiment; and

FIG. 18 is a schematic front view of an aircraft including one or more structural component based on a preform produced by the system or method of the disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

It will be appreciated that common and well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not necessarily required. It will also be understood that the terms and expressions used in the present specification have the ordinary meaning as it accorded to such terms and expressions with respect to their corresponding respective areas of inquiry and study, except where specific meanings have otherwise been set forth herein.

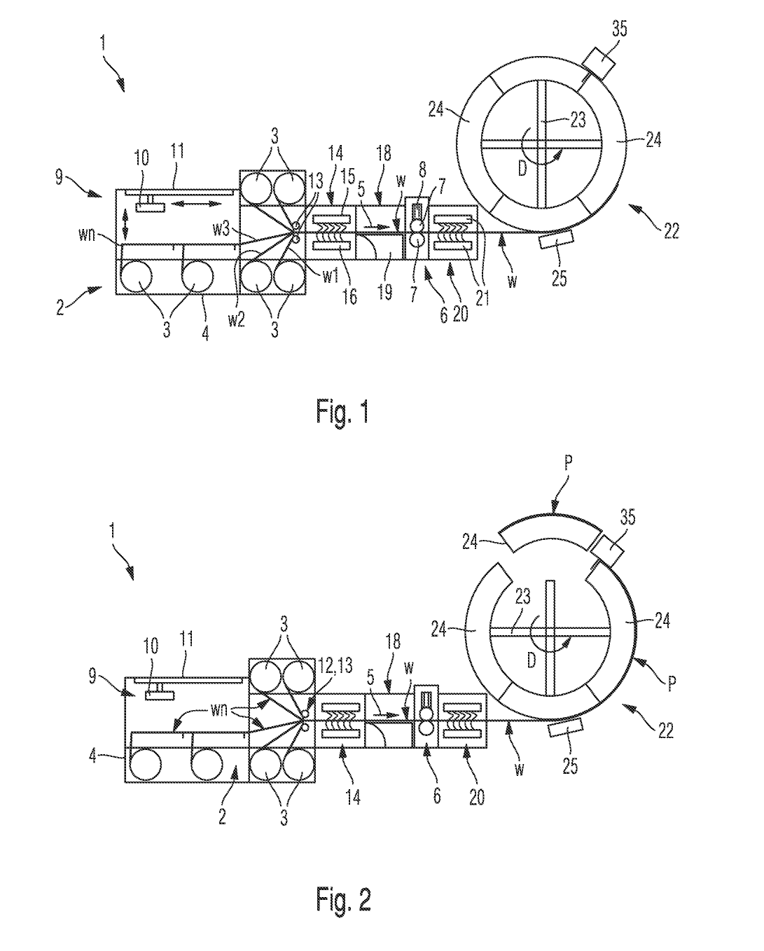

With reference to FIGS. 1 and 2 of the drawings, a system 1 for producing a composite preform P according to an embodiment is shown in two different stages of preform production. The system 1 of this embodiment is designed for continuously preforming reinforcing material for use in fabrication of fibre-reinforced composite components (not shown). The system 1 includes a supply 2 of the preform material, which is provided in the form of continuous webs wn of woven or non-woven fabric on rolls or reels 3, which are rotatably mounted on a support frame 4 of the system 1. That is, the webs w1, w2, w3, etc. are continuous sheets or strips of material which are drawn from respective individual rolls or reels 3 in the material supply 2 and consolidated into a compound web w. In other words, the compound web w comprises a plurality of layers of preform material superposed upon one another and conveyed along a process path 5 of the system 1. To this end, the system 1 includes a feeding device 6 having at least one pair of rollers 7 driven by an electric motor 8. The rollers 7 engage the compound web w of multiple layers of preform material at upper and lower sides thereof and act to both draw these layers w1, w2, w3, etc. from their respective rolls or reels 3 in the material supply 2 and also feed or convey these layers in the compound web w along the process path 5 through the system 1. The separate webs or layers wn of the preform material may include one or more types of reinforcing fibres, but carbon fibres are one specific possiblity. The fibres may be “dry” or may include resin or polymer coatings to assist bonding and shaping in production of the preform. The webs wn of preform material may also include one or more film or resin or binder layer, and optionally also a wire mesh layer for lightning protection in aircraft application.

In addition to the plurality of continuous superimposed webs w1, w2, w3, etc. of reinforcing fabric from the respective rolls or reels 3 in the material supply 2, the compound web w of preform material may also include non-continuous sections of material. In this regard, the system 1 of this embodiment further includes a laying device 9 having a transport head 10 that is movable in at least two and generally three or more degrees-of-freedom for picking-up, transporting, and laying or placing discrete or non-continuous additional sections of reinforcing material on or between the continuous webs wn of preform material drawn from the individual rolls or reels 3. To this end, the transport head 10 may be movably mounted on rails 11 and drivable, e.g. via servo motors (not shown), for movement in the directions of arrows A, B to introduce or lay the discrete or non-continuous sections of preform material onto the process path 5.

The driven rollers 7 of the feeding device 6 pull or draw the layers of preform material through a consolidating device 12, and more particularly between rollers 13 of the consolidating device 12. As the rollers 13 are resiliently or spring biased towards one another, they act to consolidate or compress both the continuous and non-continuous portions of the preform material into the compact compound web w, which then passes into a first heating device 14 arranged on the process path 5 of the system 1.

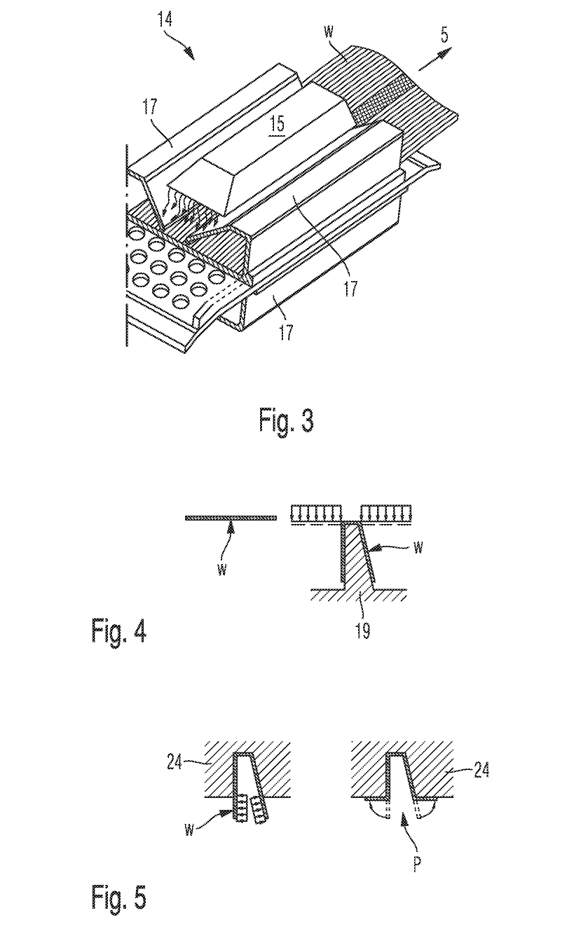

Referring to FIG. 1 in conjunction with FIG. 3 of the drawings, it will be seen that the first heating device 14 comprises upper and lower heating units 15, 16 for heating the compound web w of preform material from upper and lower sides, respectively, in order to rapidly transmit heat to the middle of the web w. In this embodiment, the heating units 15, 16 are infrared (IR) heaters, of which in FIG. 3 only the upper heating unit 15 is denoted. In one example, the two heating units operate at about a constant 190° C. and from a starting temperature of the web at approx. 25° C., the temperature of the middle layers rises to about 100° C. after a heating period of between about 30 s and about 120 s, generally between about 40 s and about 90 s. As can be seen in FIG. 3 of the drawings, the heating device may incorporate one or more shield members 17 for shielding a part of the preform material web w from heat transmitted by the heating unit 15. In FIG. 3, for example, two shield members 17 are provided to confine the main heating effect to a central region or strip of the compound w.

With reference now to FIG. 4 of the drawings, a preliminary forming procedure for the compound web w of preform material is shown schematically. In FIGS. 1 and 2 of the drawings, for example, this procedure could take place in a preliminary forming station 18 directly downstream of the first heating device 14. In this regard, the preliminary forming station 18 may comprise a mould or form 19 upon or over which the cross-sectional profile of the compound web w of preform material undergoes an initial shaping or moulding procedure. As shown in FIG. 4, for example, the substantially flat or planar web w comprising multiple layers preform material may be pressed or folded over an up-standing form 19 to generate an inverted V- or U-shape. Instead of the preliminary forming in FIG. 4, however, the system 1 of the embodiment shown in FIGS. 1 and 2 may provide a much smaller or more limited indentation in the central region of the preform material web w. Downstream of the feeding device 6, a second heating device 20 is provided for re-heating the compound web w of preform material before that material enters a main or primary forming device 22 of the system 1. In this way, the second heating device 20 again warms and softens the resin or binder material in the web w to render the layers of preform material flexible and readily deformable in the forming device 22.

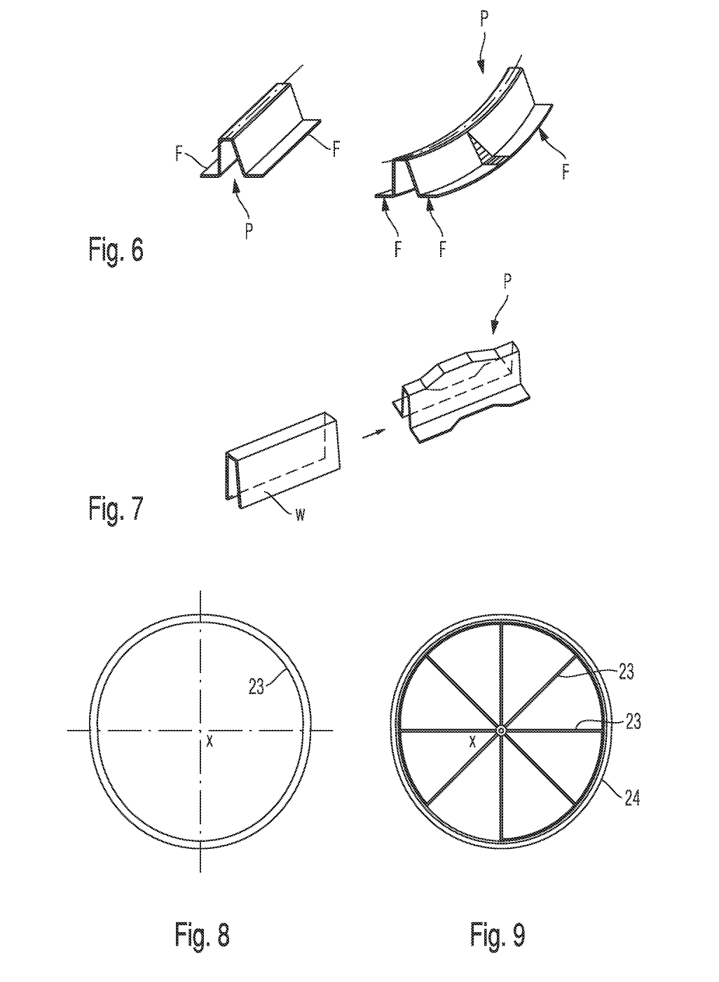

The configuration and operation of the main forming device 22 of system 1 will be described with reference to FIGS. 1 and 2 as well as to FIGS. 5 to 16 of the drawings. The forming device 22 is designed for continuously preforming the web w of composite reinforcing material and, for this purpose, has a rotary frame 23 with a plurality of moulds or forms 24 on or around a circumference of that rotary frame 23. In this embodiment, the system 1 is specifically concerned with forming a composite preform P having a cap or omega (Ω) profile, i.e. basically a channel section with an inverted V- or U-shape having flange-type footings F extending along its length on opposite sides of the channel, as seen in FIG. 6. Such profiles or cross-sections are typical for structural components, such as ribs or stringers, employed in fuselage or airframe structures of aircraft and spacecraft. FIG. 7 of the drawings simply demonstrates the desired capabilities of the system 1 for locally modifying a basic inverted V- or U-shape from FIG. 4 into a preform profile having a complex and variable cross-section.

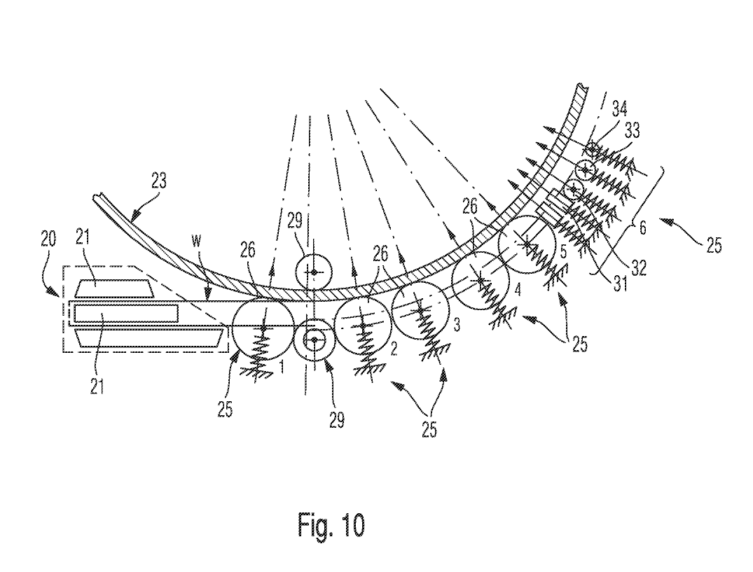

With reference now to FIG. 10 of the drawings, a partial view of the system 1 shows the layers of preform material in the compound web w emerging between upper and lower heating units 21 of the second heating device 20 and entering a series of forming stations 25 arranged at a circumference of the rotary frame 23. The forming stations 25 in the series are numbered consecutively (nos. 1 to 6) in FIG. 10 and each of these individual forming stations 25 and its operation is described in more detail with reference to FIGS. 11 to 16.

FIG. 11 of the drawings shows each of the first five forming stations 25 (i.e. nos. 1 to 5) shown schematically in FIG. 10 in a single perspective view. Each of the forming stations 25 is fixed on the support frame 4 such that the rotary frame 23 rotates about its axis X relative to the stations 25. Also, each of these five forming stations 25 includes a wheel or roller 26 that is resiliently mounted to be biased via one or more springs 27 so that an edge 28 of the wheel 26 is pressed into a channel-like cavity of the mould or form 24 arranged on the circumference of the rotary frame 23. The springs 27 bias the wheels in the radially inward direction towards the rotary axis X. These wheels 26 of the forming stations 25 are not directly driven. Rather, the rotary frame 23 is itself driven via drive rollers 29, which rotate the frame 23 and the moulds or forms 24 on its circumference about the rotary axis X. The forming wheels or rollers 26 at each forming station 25 therefore counter-rotate due to their contact with the moving web w and circumferential moulds 24 on the rotary frame. In this regard, a tangential speed of the rotary frame 23, and thus of the moulds 24, is substantially the same as a linear speed of the compound web w of preform material as it is being fed by the feeding device 6 along the process path 5 of the system 1. The rotary frame 23 therefore continues to convey and draw the layers of preform material in the web w at substantially the same speed.

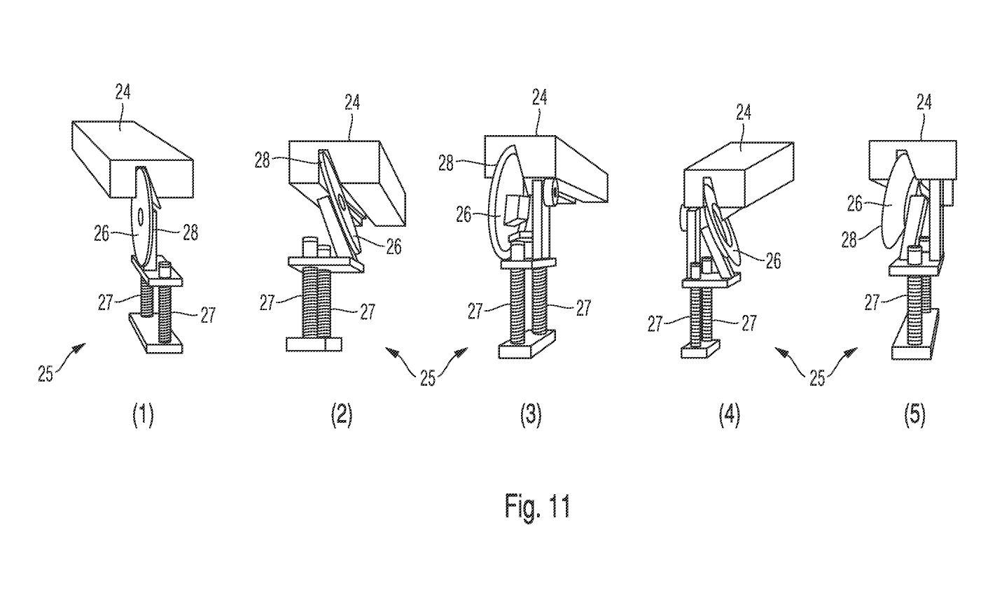

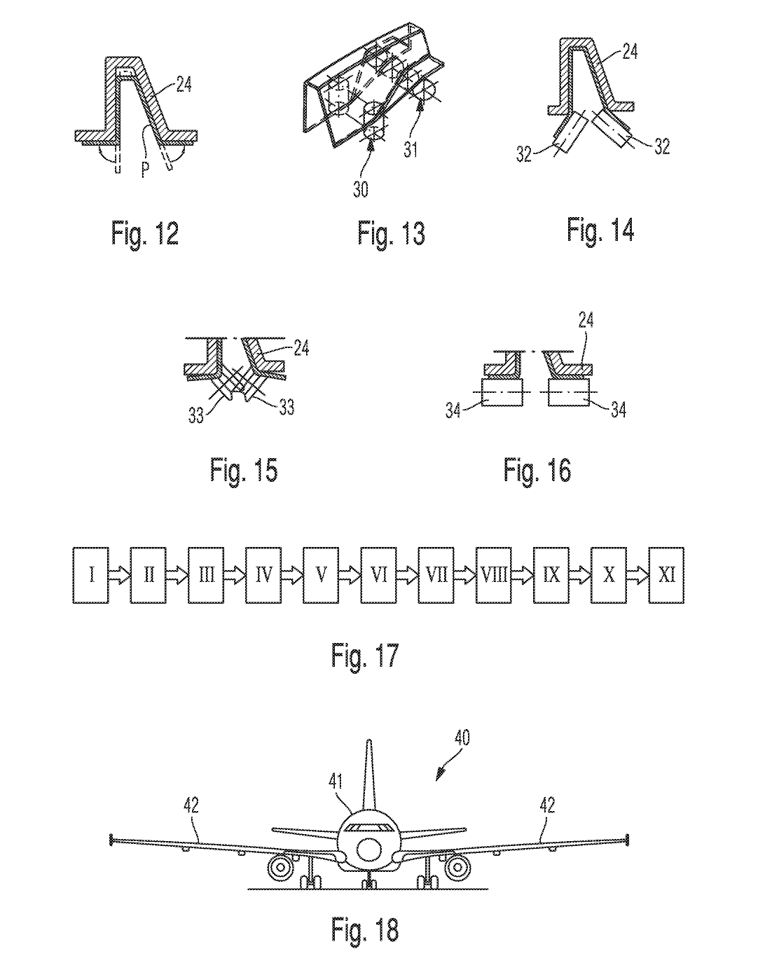

Referring now to FIGS. 12 to 16 of the drawings, details are illustrated of a final shaping and moulding of the preform P as the compound web w passes through the last forming station no. 6 of FIG. 10. FIG. 12 illustrates a cross-section of the mould 24 and a desired cross-sectional profile of the preform P to be produced. FIG. 13 illustrates the rollers 30, 31 at an initial part of final forming station 25 (no. 6), which begin to impart flange-like footings F to the cross-sectional profile of the preform P. FIGS. 14 to 16 respectively show the rollers 32, 33, 34, with which the flanges or footings of the preform profile are further formed and completed.

With reference again to drawing FIG. 2, it will be seen that the system 1 includes a cutting device 35 for severing the preformed compound web w after the shaping or moulding of the web material in a respective mould 24 on the rotary frame 23 has been completed. The cutting device 35 includes a blade 36 for cutting the newly produced preform P, which is still held in its respective mould 24, across an end of that mould 24. As can be seen in FIG. 2, the entire mould 24 with preform P can then be separated or demounted from the rotary frame 23 and transported to an infusion station (not shown), at which wet resin is then injected into a cavity of the mould and the preform P held therein to produce an omega (Ω) profile fibre-reinforced composite stringer or rib component. The resin is typically pressurized and forced into the preform P under vacuum in a Resin Transfer Molding (RTM) process or may be pulled into the cavity under vacuum in a Vacuum Assisted Resin Transfer Molding (VARTM) or Resin Infusion (RI) process. In the interim, a new mould 24 can be placed on the rotary frame 23 of the forming device 22 in the system 1 and a further preform P produced.

Having described the system 1, reference is now made to drawing FIG. 17 which shows a block diagram that schematically illustrates a method essentially corresponding to the system 1 described above. The boxes of the diagram are numbered I to XI to denote discrete or individual stages of the method according to this embodiment. In this regard, the first box I of FIG. 17 represents supplying one or more layers or webs wn of reinforcing material, generally continuous webs or layers on reels or spools 3, for producing a composite preform P. The second box II represents feeding these layers or webs wn of material supplied in an overlapping or superposed arrangement along a process path 5, e.g. via a feeding device which may, for example, comprise driven rollers 7 between which the layers of material wn are drawn from respective reels or spools 3. The third box III represents applying a patch (i.e. discrete, non-continuous additional section or layer) of material to the one or more layers or webs wn already present via a laying device 9, i.e. laying or inserting a discrete or non-continuous section of preform material on or between the one or more layers wn fed along the process path. The fourth box IV then represents consolidating or pressing together the multiple layers of material by compressing the superposed layers between a pair of rollers to provide a consolidated compound web w of the layered preform material, which is fed along the process path 5.

The fifth box V in the diagram of FIG. 17 represents heating the compound web w via a first heating device 14 to activate a resin or binder material provided in the layers of the compound web w before shaping or moulding the preform material. The sixth box VI represents a preliminary forming operation in which initial shaping or moulding of the compound web w takes place as the web travels along the process path 5, by subjecting the cross-sectional profile of the one or more layers wn of preform material to a preliminary shaping or moulding before the one or more layers wn reach a primary or main forming stage The seventh box VII of the diagram then represents a second heating operation in which further heating (or re-heating) of the compound web w takes place, generally again from both upper and lower sides of the web to soften and activate a binder or resin material in the compound web prior to a main or primary forming stage in the production of the composite preform P. The eighth box VIII of the diagram represents a first forming corresponding to one or more forming stations 25 in which a wheel member 36 presses and shapes the deformable compound web w of preform material into a female mould such that the web progressively assumes the form of the mould 24. The ninth box IX of the diagram represents forming corresponding to the processes at the forming station no. 6 at which both cross-sectional and longitudinal forming of the web material is finalized in the mould on a periphery or circumference of the rotary frame 23 of the forming device 22. The tenth box X of FIG. 17 represents cutting a completed preform from the continuous web w at an edge of a respective mould 24 to separate and isolate that completed preform P. The final box XI of the diagram represents now removing the respective moulding tool 24 from the rotary frame 23 in order to transport the preform to an infusion station for infusion with wet resin to fabricate a composite component with the preform produced according to the present disclosure.

The feeding of second box II may comprise feeding the one or more layers wn of preform material as elongate, and sometimes continuous, strips or sheets in a longitudinal direction along the process path 5, wherein the forming comprises shaping or moulding the cross-sectional profile of the one or more layers wn transverse to the longitudinal direction.

In that case, the forming of the ninth box IX may include a plurality of discrete forming operations in series along the process path 5 to progressively shape or mould the cross-sectional profile of the preform material as the one or more layers wn are fed along the process path 5. This may be done by shaping or moulding the cross-sectional profile of the preform material on a circumference of a rotary frame 23. Optionally, the rotary frame 23 may rotate with a tangential speed at a circumference thereof substantially equal to a speed at which the one or more layers wn of preform material is fed in the feeding.

The rotary frame 23 may for this purpose include a plurality of forms or moulds 24 arranged around the circumference thereof, wherein the plurality of forms or moulds 24 are separately detachable from the rotary frame 23.

When the material supply 2 comprises at least one spool or reel 3 of preform material, the feeding may comprise drawing the one or more layers wn of preform material from the material supply 2 and feeding or conveying the one or more layers wn along the process path 5 by driving at least one pair of rollers 7.

As noted above, the preforms P produced with the system 1 and method of the disclosure are further processed into structural components, such as stringers and/or ribs, e.g. for use in the aeronautical and automotive industries. As an example, FIG. 18 of the drawings shows an aircraft 40 with a fuselage or airframe structure 41 and wings 42 that may incorporate such composite components, like stringers and/or ribs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A system for producing a composite preform, comprising:
a feeding device for feeding one or more layers of preform material from a material supply along a process path;
a heating device arranged in the process path for heating the one or more layers of the preform material fed along the process path to soften or activate a resin or binder in the one or more layers; and
a forming device arranged in the process path downstream of the heating device and configured to shape or mould a cross-sectional profile of the one or more layers of preform material as the one or more layers of preform material are fed along the process path.

2. The system according to claim 1, wherein the feeding device is configured to feed the one or more layers of preform material as elongate, and continuous, strips or sheets in a longitudinal direction along the process path, wherein the forming device is configured to shape or mould the cross-sectional profile of the one or more layers of preform material transverse to the longitudinal direction.

3. The system according to claim 2, wherein the forming device includes a plurality of forming stations arranged in series along the process path to progressively shape or mould the cross-sectional profile of the one or more layers of preform material as the one or more layers of preform material are fed along the process path.

4. The system according to claim 3, wherein the forming device includes a rotary frame having at least one form or mould on a circumference of the rotary frame in or on which the cross-sectional profile of the preform material is shaped or moulded.

5. The system according to claim 4, wherein the rotary frame is configured to rotate at a speed for which the tangential speed of the form or mould on the circumference of the rotary frame is substantially the same as a speed of the one or more layers of preform material fed by the feeding device.

6. The system according to claim 4, wherein the rotary frame comprises a plurality of forms or moulds arranged around the circumference of the rotary frame, and wherein the plurality of forms or moulds are separately detachable from the rotary frame.

7. The system according to claim 1, wherein the material supply comprises at least one spool or reel of the fiber material.

8. The system according to claim 1, further comprising a laying device for laying or inserting a discrete or non-continuous section of a preform material on or between the one or more layers of preform material fed along the process path.

9. The system according to claim 8, wherein the laying device comprises a transport head for picking-up, transporting, and laying or inserting the discrete or non-continuous section on or between the one or more layers of preform material.

10. The system according to claim 1, further comprising a preliminary forming station downstream of a first heating device, the preliminary forming station comprising a mould or form in or on which the cross-sectional profile of the one or more layers of preform material undergoes a preliminary shaping or moulding before the one or more layers of preform material reach the forming device.

11. The system according to claim 10, further comprising a second heating device arranged in the process path downstream of the preliminary forming station for heating the one or more layers of preform material fed along the process path before the one or more layers of preform material reach the forming device.

12. The system according to claim 1, further comprising a consolidating device for consolidating or pressing together the one or more layers of preform material fed along the process path.

13. A method of-producing a composite preform, especially of continuously preforming a reinforcing material for a composite component, comprising:
feeding one or more layers of preform material from a material supply along a process path;
heating the one or more layers of the preform material fed along the process path to activate or soften a resin or binder in the one or more layers; and
forming or shaping a cross-sectional profile of the one or more layers of preform material as the one or more layers of preform material are fed along the process path to produce a composite preform.

14. The method according to claim 13, further comprising embedding the composite preform in a matrix material.

15. The method according to claim 14, wherein the matrix material comprises a thermoplastic or thermo-setting resin.

16. The method of claim 14, wherein the composite component is a structural component for an aircraft or spacecraft.

17. The system according to claim 1, wherein the feeding device comprises at least one pair of driven rollers for drawing the one or more layers of preform material from the material supply and feeding them along the process path.

18. The method according to claim 14, wherein the matrix material is selected from the group comprising epoxy resin, polyester resin and vinyl ester resin.
